(19) United States
(12) Patent Application Publication
(10) Pub. No.: US 2018/0174402 A1
(43) Pub. Date: Jun. 21, 2018

(54) GAMING SYSTEMS AND METHODS HAVING MULTIPLE GAME TERMINALS, MACHINES AND/OR PLAYER POSITIONS AND ONE OR MORE BALL BLOWERS FOR PRIZE DETERMINATION

(71) Applicant: Scott D'Avanzo, Ladera Ranch, CA (US)

(72) Inventor: Scott D'Avanzo, Ladera Ranch, CA (US)

(21) Appl. No.: 15/846,050

(22) Filed: Dec. 18, 2017

Related U.S. Application Data
(60) Provisional application No. 62/435,709, filed on Dec. 16, 2016.

(51) Int. Cl. G07F 17/32

(52) U.S. Cl. CPC G07F 17/3286; G07F 17/3241; G07F 17/3246

(57) ABSTRACT

A game system utilizing one or more ball blowers to randomly generate a prize or award based on a triggering outcome of an underlying game of chance. The ball blower contains a series of balls depicting information indicative of a prize or award. The ball blower may automatically activate responsive to a triggering outcome or utilize an interface through which a player or dealer may activate the ball blower.

### CROSS-REFERENCE

This application claims priority to U.S. Patent Application No. 62/435,709 filed Dec. 16, 2016 which is incorporated herein for all purposes.

### FIELD OF THE INVENTION

The embodiments of the present invention relate to a gaming system and method involving multiple electronic terminals and a common ball blower configured to generate prizes/awards related to the outcomes of the games of chance facilitated by the game terminals.

### BACKGROUND

Gaming continues to expand in the United States and throughout the world. The expansion of gaming has caused the need for new and improved games of chance and related systems and methods for facilitating the same.

It would be advantageous to develop a system and method for utilizing one or more ball blowers to determine prizes/awards associated with game terminals linked thereto.

### SUMMARY

Accordingly, one system involves a plurality of game terminals, each of said game terminals having at least a video display and user interface, each of said game terminals configured to allow players to play one or more electronic games of chance; one or more processors and memory associated with said plurality of game terminals, said one or more processors controlling certain operations of the plurality of game terminals; and a ball blower configured to randomly generate a prize or award associated with a prize-triggering outcome of one of said plurality of game terminals.

Another system involves a game system including one or more processors, memory, multiple player positions at a gaming table and a video display for presenting a virtual dealer to conduct a game of chance for players at each occupied player position, each of said player positions including means for accepting wagers, collecting losing wagers and paying out winning wagers; and a ball blower configured to randomly generate a prize or award associated with a prize-triggering outcome of one of more of said plurality of game terminals. A live dealer may also deal games for players at multiple player terminals.

In one embodiment, the ball blower is activated automatically responsive to a prize-triggering outcome (e.g., card arrangement, roulette outcomes, craps outcomes, etc.) of one of said plurality of game terminals or a prize-triggering outcome at one of the player positions. Alternatively, a player at a game terminal or player position where a prize-triggering outcome occurs is permitted to activate the ball blower utilizing a user interface (e.g., touch screen) associated with the game terminal or player position. If the ball blower is being used while another player obtains a prize-triggering game outcome, the player may be alerted that he or she will have the opportunity to activate the ball blower when the previous ball blower activation is complete. The player may be permitted to continue playing the underlying game while he or she waits for the ball blower to be ready.

Other variations, embodiments and features of the present invention will become evident from the following detailed description, drawings and claims.

### BRIEF DESCRIPTION OF THE DRAWINGS

FIG. 1 illustrates a system involving a plurality of game terminals and ball blower according to the embodiments of the present invention;

FIG. 2 illustrates a system involving a virtual dealer system having a ball blower according to the embodiments of the present invention;

FIG. 3 illustrates a flow chart detailing a method of conducting a game of chance according to the embodiments of the present invention;

FIG. 4 illustrates an exemplary ball blower which may be used with the embodiments of the present invention; and

FIG. 5 illustrates a system involving a plurality of gaming machines and ball blower according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming device” and “gaming machine” should be understood to be any one of a general purpose computer, as for example a personal computer or a laptop computer, a client computer configured for interaction with a server, a special purpose computer such as a server, or a smart phone, tablet computer, personal digital assistant or any other machine adapted for executing programmable instructions in accordance with the description thereof set forth herein. A “game terminal” can be any device having a video monitor and user interface and in communication with a processor and memory. The processor and memory may be local to the game terminals or remote. RFID, readers, biometrics and other technologies may be integrated into the systems disclosed below.

Applicant incorporates herein by reference U.S. Pat. No. 7,059,603 entitled “Wagering Game” which issued Jun. 13, 2006.

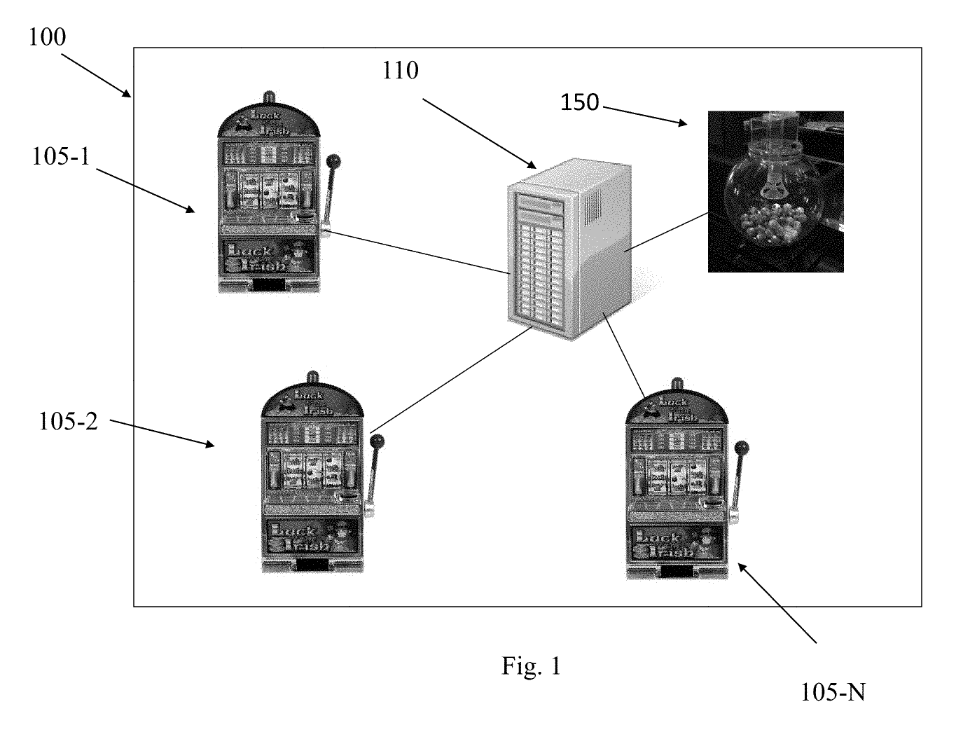

FIG. 1 shows a system 100 comprising broadly a plurality of electronic game terminals 105-1 through 105-N (shown as slot machines) and a ball blower 150. A system 100 with a large number of game terminals may utilize multiple ball blowers 150 to ensure ball blowers are available when a prize-triggering game outcome occurs at one or more of the game terminals. In one embodiment, a server 110 or other type of storage device is communicatively linked to the plurality of electronic game terminals 105-1 through 105-N. The game terminals 105-1 through 105-N may collectively form a single unit or may be individual units. The server 110 includes one or more processors running game software and memory storing relevant data and information. A random number generator associated with the one or more processors facilitates generation of the game outcomes. In another embodiment, the electronic game terminals 105-1 through 105-N may each include a processor and memory (e.g., smart devices). With a server 105, the ball blower 150 is communicatively linked to said server 150 and/or said plurality of electronic game terminals 105-1 through 105-N for reasons set forth below.

The electronic game terminals 105-1 through 105-N may facilitate any games of chance including blackjack, craps, roulette, baccarat, keno, video poker, etc. The games may be player v. virtual dealer or player v. player. The games may have outcomes generated by random number generators or may be skill-based.

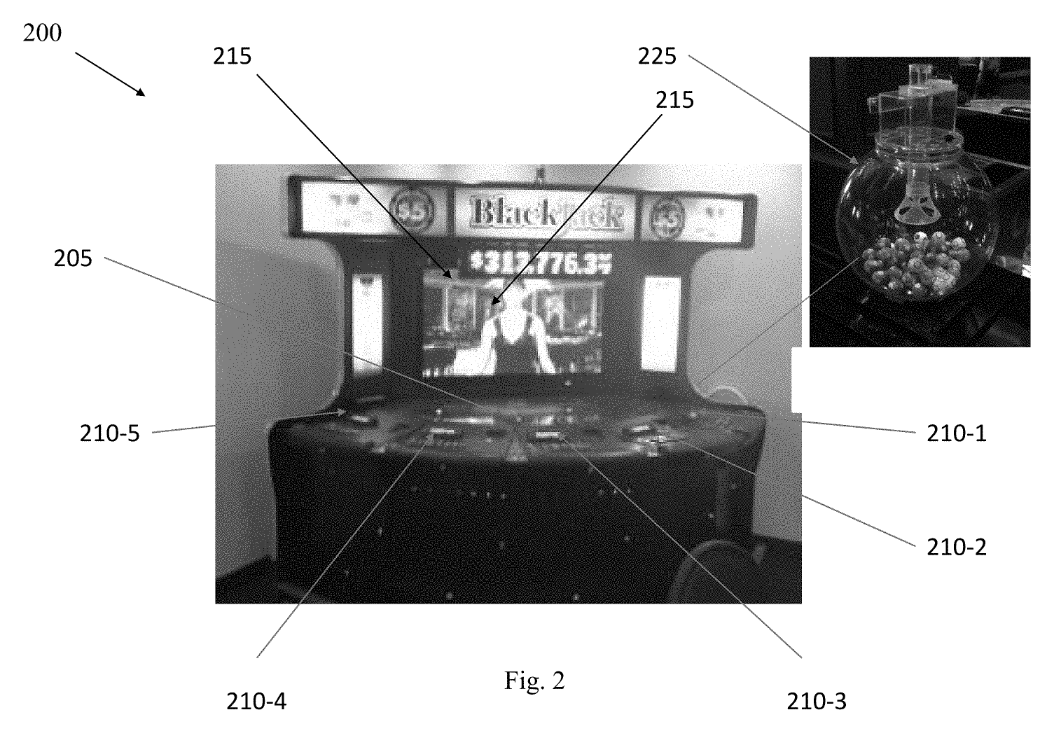

FIG. 2 shows a system 200 comprising broadly a gaming table 205 accommodating multiple player positions 210-1 through 210-5, a display 215 for presenting a virtual dealer and ball blower 220. The system 200 may also operate without a game table and just player terminals. The virtual dealer may be animated, pre-recorded live footage, computer generated or otherwise created to conduct the game of chance played at system 200. One or more processors run game software and memory storing relevant data and information. A random number generator associated with the one or more processors facilitates generation of the game outcomes. Each player position 210-1 through 210-5 includes means for accepting a wager, collecting losing wagers and paying winning wagers. The means may comprise bill validators, bill acceptors, credit meters, bar code readers, QR code readers, near field communication devices, etc. The ball blower 220 is communicatively linked to the one or more processors.

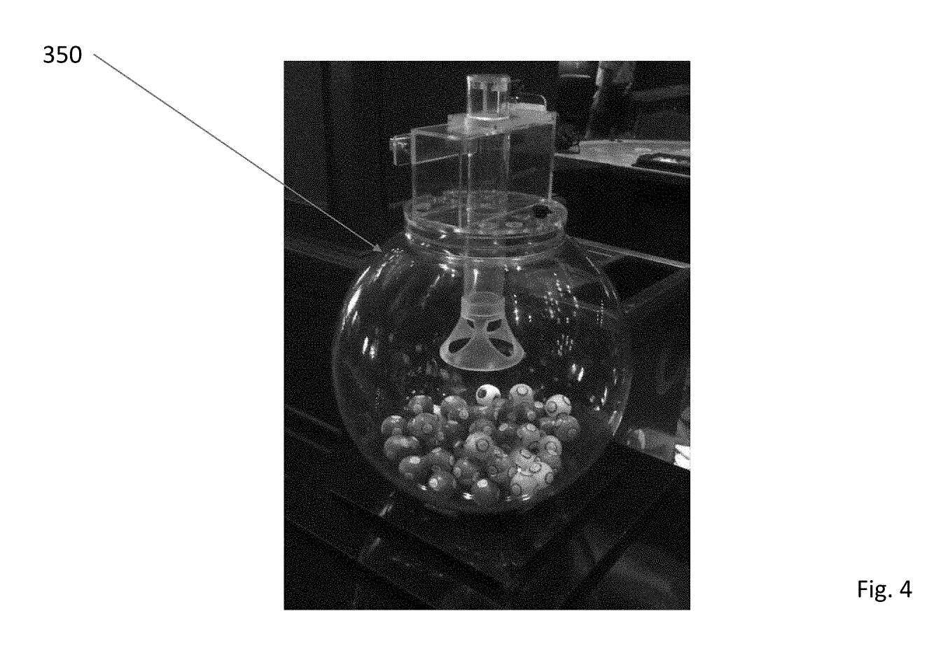

Ball blower 300, as shown in FIG. 4, is configured to determine a prize or award by randomly selecting one or more balls contained therein. The balls 305 contained by the ball blower 300 may depict awards and/or prizes and/or symbols and/or colors representing awards and/or prizes. The operation of the ball blower 300 is conventional in nature wherein the balls 305 are scrambled/jumbled within a ball blower chamber 310 via an air source until one or more random balls 305 are selected via a capture tube 315.

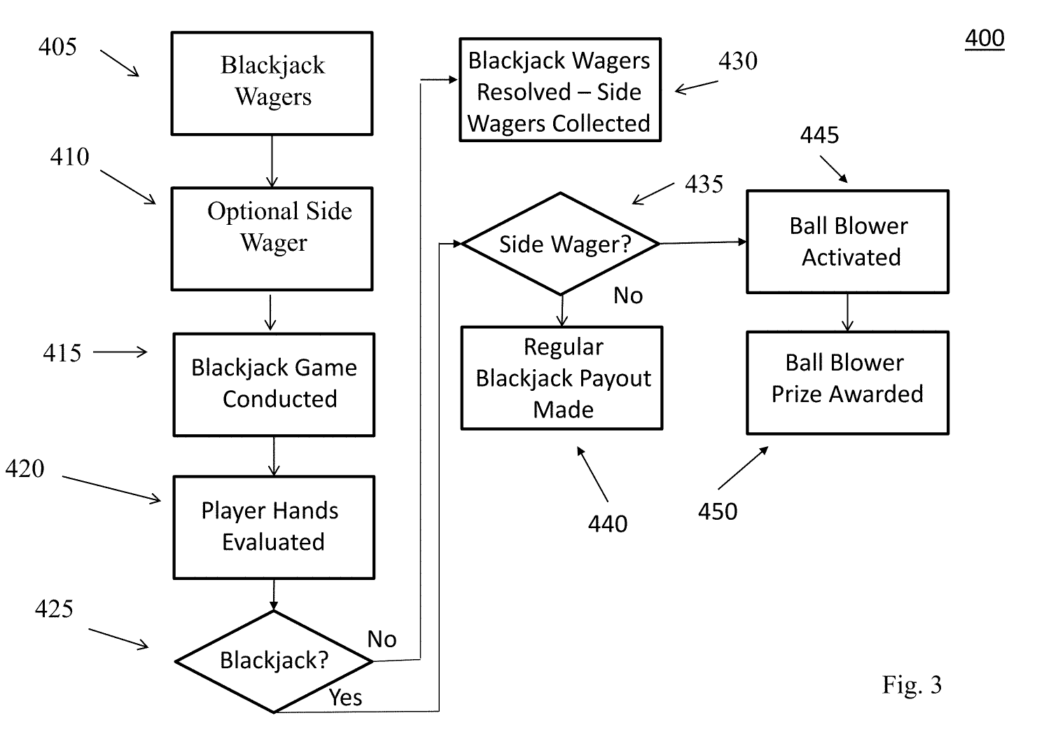

The ball blowers 150, 300 are configured to activate responsive to prize-triggering outcomes at the game of chance being conducted at the systems 100, 200. With a blackjack game, the prize-triggering game outcome may be a player and/or the dealer obtaining a blackjack. With Baccarat, the prize-triggering game outcome may be a tie hand. Any game of chance, including craps, roulette, baccarat, Three Card Poker®, Let it Ride®, poker, video poker, keno, bingo, etc., may be the underlying game facilitated by the systems 100, 200. FIG. 3 shows an exemplary ball blower 350 that may be used with the embodiments of the present invention. 100291 FIG. 3 shows a flow chart 400 detailing how the systems 100, 200 are used to conduct a blackjack game. As set forth above, any game of chance may be utilized by the embodiments of the present invention. At 405, players place a blackjack game wager. At 410, players have the option to place a side wager corresponding to certain prize-triggering outcomes. The side wager range is dictated by the operator. In this instance, the prize-triggering outcomes relate to the player receiving a blackjack (i.e., 2-card 21). At 415, the blackjack game is conducted according to conventional rules thereof. At 420, player hands are evaluated. At 425, it is determined if any player hands comprise a blackjack. If the hand is not a blackjack, at 430, the blackjack wager is resolved and side wager, if placed, is collected. If, at 425, the hand is a blackjack, at 435, it is determined if the player placed the side wager. If not, at 440, the player is paid the prevailing blackjack payout (e.g., 3 to 2 or 6 to 5). If, at 435, it is determined that the player placed the side wager, at 445, the player is provided the opportunity to activate the ball blower 150, 300 (or it activates automatically) associated with the respective system 100, 200. Activating the ball blower 150, 300 may be undertaken by a user-interface such as a touch screen icon, a tangible button or otherwise. At 450, a prize randomly generated by the ball blower 150, 300 is credited or otherwise provided to the player. In one embodiment, the available prizes each exceed the conventional payout to encourage the placements of the side wager. In one embodiment, the ball blower may contain one or more jackpot balls which greatly exceed the conventional blackjack payout. For example, a jackpot ball may depict an award of 300 to 1 the side wager.

While the flowchart 400 details a player activating the ball blower 150, 300, it is also evident that the ball blower 150, 300 may be activated automatically by the system 100, 200 responsive to a prize-triggering game outcome. Also, with a player-activated ball blower system, if the player fails to activate the ball blower 150, 300 in a pre-established time period (e.g., 15 seconds), the system 100, 200 may activate the ball blower 150, 300 automatically.

If any system 100, 200 results in multiple players obtaining a prize-triggering game outcome, the system 100, 200 places the players into a queue to activate the ball blower 150, 300.

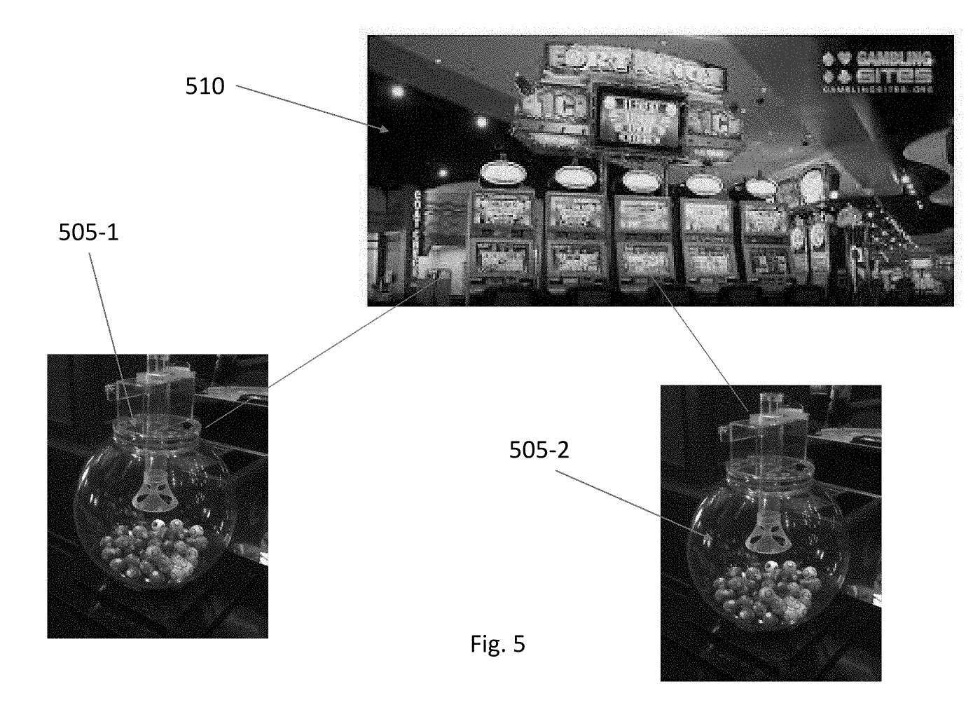

In another system 500, as shown in FIG. 5, ball blower 505-1, 505-2 may be communicatively linked to bank of electronic gaming machines (e.g., slot machines) 510. Like systems 100, 200, system 500 utilizes prize-triggering game outcomes to activate the ball blower 500. In this instance, the gaming machines offer the ability for the players to place a side wager for the opportunity to activate the ball blower 500 responsive to a prize-triggering game outcome. In another embodiment, the ball blower may be configured to select multiple balls at once whereby each selected ball belongs to a different player terminal, player position or player. For example, with a blackjack game where players may place a side wager on a dealer blackjack, multiple players may win simultaneously when a dealer hits a blackjack. In such an embodiment, the ball blower may select at once a number of balls corresponding to a number of players winning the side bet. The balls may be presented collectively in a transparent tube with each ball identified with the corresponding winning player.

In some embodiments, balls depicting a combination of colors, symbols and/or letters may or may not award a price. For example, the ball blower may contain red, white and blue balls wherein balls drawn in a specific order may award a larger prize or progressive prize while no specific order may award no prize or a smaller prize. In other words, activation of the ball blowers may not always result in a prize being awarded. In another embodiment, there may be multiple ball blowers with varying prize amounts from small to large which may be activated based on specific game outcomes (the more unlikely the larger the potential prize) and/or an amount of the side wager.

In another embodiment, one or more ball blowers may be utilized with a plurality of live table games. The live table games include a live dealer and may or may not include digital displays at each player position wherein the digital displays allow players to make wagers and receive digital credits rather than use game chips. In such an embodiment, game outcomes at the live table games trigger the use of the one or more ball blowers. Depending on the embodiment, the one or more ball blowers may be positioned in the game pit area or proximate thereto.

In another embodiment, the ball blower of the system 100, 200 or 500 may be virtual in nature. In one such embodiment, the ball blower is in the form of a video on a display device. Like the physical ball blower, the virtual ball blower is configured, via software, to generate random outcomes or outcomes based on a math model.

In another embodiment, the ball blower may contain fifty-two balls each depicting a unique playing card from a conventional deck of cards having cards ranked from 2-9, Jack, Queen, Kings and Ace for each of four suits—diamonds, hearts, spades and clubs. In one embodiment, the ball blower may be configured to draw five balls to determine a random five-card poker hand from which payouts may depend. More or less than five balls may be drawn to determine game and/or wager outcomes.

Although the invention has been described in detail with reference to several embodiments, additional variations and modifications exist within the scope and spirit of the invention as described and defined in the following claims.

I claim:

1. A system comprising:
a plurality of game terminals, each of said game terminals having at least a video display, user interface and wager acceptance device, each of said game terminals configured to allow players to play one or more electronic games of chance;
one or more processors and memory associated with said plurality of game terminals, said one or more processors controlling one or more operations of the plurality of game terminals; and
one or more ball blowers each containing multiple balls, said one or more ball blowers configured to randomly generate a prize or award based on one or more selected balls responsive to a prize-triggering outcome at one or more of said plurality of game terminals.

2. The system of claim 1 further comprising one or more servers each with one or more processors and memory, and in communication with each of said game terminals.

3. The system of claim 1 wherein each game terminal includes a processor and memory.

4. The system of claim 1 further comprising multiple ball blowers each having varying amounts of potential payouts and/or prizes.

5. The system of claim 1 further comprising multiple ball blowers corresponding to an amount of a side bet placed during an underlying game.

6. The system of claim 1 further comprising multiple ball blowers corresponding to an amount of a side bet placed during an underlying game of chance.

7. The system of claim 1 further comprising an interface for players to activate said one or more ball blowers.

8. The system of claim 1 wherein said ball blower contains fifty-two balls, each depicting unique playing card indicia.

9. A system comprising:
a game system including one or more processors, memory, multiple player positions at one or more gaming tables and a video display at each of said one or more gaming tables for presenting a virtual dealer to conduct a game of chance at each of said one or more gaming tables, each of said player positions including one or more mechanisms configured to accept wagers, collect losing wagers and pay winning wagers; and
one or more ball blowers each containing multiple balls, said one or more ball blowers configured to randomly generate a prize or award based on one or more selected balls responsive to a prize-triggering outcome at one or more of said player positions.

10. The system of claim 9 further comprising an interface for players to activate said one or more ball blowers.

11. The system of claim 9 wherein said one or more mechanisms comprise one or more of the following: bill validator, bill acceptor, credit meter, bar code reader, QR code reader, RFID and near field communication device.

12. The system of claim 9 further comprising multiple ball blowers each having varying amounts of potential payouts and/or prizes.

13. The system of claim 9 further comprising multiple ball blowers corresponding to an amount of a side bet placed during an underlying game.

14. The system of claim 9 further comprising multiple ball blowers corresponding to an amount of a side bet placed during an underlying game of chance.

15. The system of claim 1 wherein said ball blower contains fifty-two balls, each depicting unique playing card indicia.

16. A system comprising:
a game system including one or more gaming tables having multiple player positions with a display interface at each of said multiple player positions, each of said player positions including one or more mechanisms configured to accept wagers, collect losing wagers and pay winning wagers;
a live dealer to deal a game of chance for players at each occupied player position; and
one or more ball blowers each containing multiple balls, said one or more ball blowers configured to randomly generate a prize or award based on one or more selected balls responsive to a prize-triggering outcome at one or more of said player positions.

17. The system of claim 16 further comprising an interface for players to activate said one or more ball blowers.

18. The system of claim 16 wherein said one or more ball blowers are positioned in or adjacent to table game pit area.

19. The system of claim 16 further comprising multiple ball blowers having varying amounts of potential payouts and/or prizes.

20. The system of claim 16 further comprising multiple ball blowers corresponding to an amount of a side bet placed during an underlying game.
